(19) United States
(12) Patent Application Publication
(10) Pub. No.: US 2016/0172789 A1
(43) Pub. Date: Jun. 16, 2016

(54) ELECTRONIC DEVICE WITH A CONNECTOR

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHUN-HUI LI, Shenzhen (CN); JIN-LONG FU, Shenzhen (CN); YAN-BANG CAO, Shenzhen (CN); LI-JUN YANG, Shenzhen (CN); WEI WU, Shenzhen (CN)

(21) Appl. No.: 14/586,136

(22) Filed: Dec. 30, 2014

(30) Foreign Application Priority Data
Dec. 11, 2014 (CN) 201410754280.5

(51) Int. Cl. H01R 13/6581; H01R 12/72

(52) U.S. Cl. CPC H01R 13/6581; H01R 12/721

(57) ABSTRACT

An electronic device includes a shielding shell, a circuit board, and a connector providing a temporary or permanent electrical connection which has integrity. The shielding shell includes at least one elastic fixing tab. The circuit board includes a signal piece and a connecting member partially surrounding the signal piece. The connector includes a plug detachably plugged in the shielding shell to electronically couple with the signal piece. The plug includes at least one notch to engage with the fixing tab.

### FIELD

The subject matter herein generally relates to electronic connections within an electronic device.

### BACKGROUND

An antenna connector is generally attached to a circuit board by gluing; however, the connector is easily detached from the circuit board.

### BRIEF DESCRIPTION OF THE DRAWINGS

Implementations of the present technology will now be described, by way of example only, with reference to the attached figures.

FIG. 1 is an exploded, isometric view of an exemplary embodiment of an electronic device.

FIG. 2 is similar to FIG. 1, but partially viewed from another angle.

FIG. 3 is an assembled, isometric view of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure relates to an electronic device with a connector.

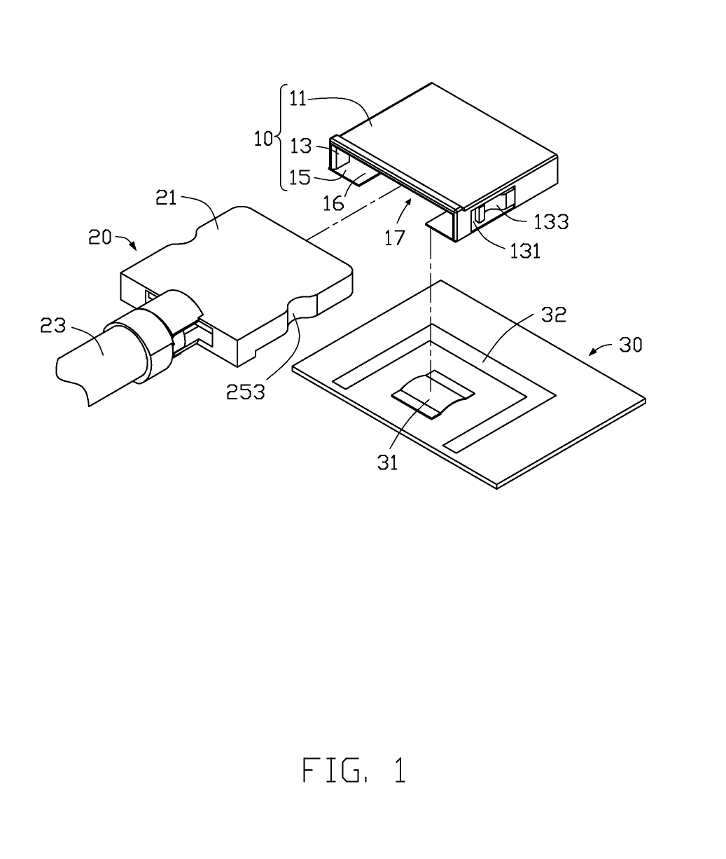

FIG. 1 illustrates an exemplary embodiment of an electronic device. The electronic device comprises a shielding shell 10, a circuit board 30, and a connector 20. An elastic signal piece 31 is attached to the circuit board 30. A U-shaped connecting member 32 surrounding the signal piece 31 is attached to the circuit board 30 and grounded. An opening of the connecting member 32 is near a front edge of the circuit board 30.

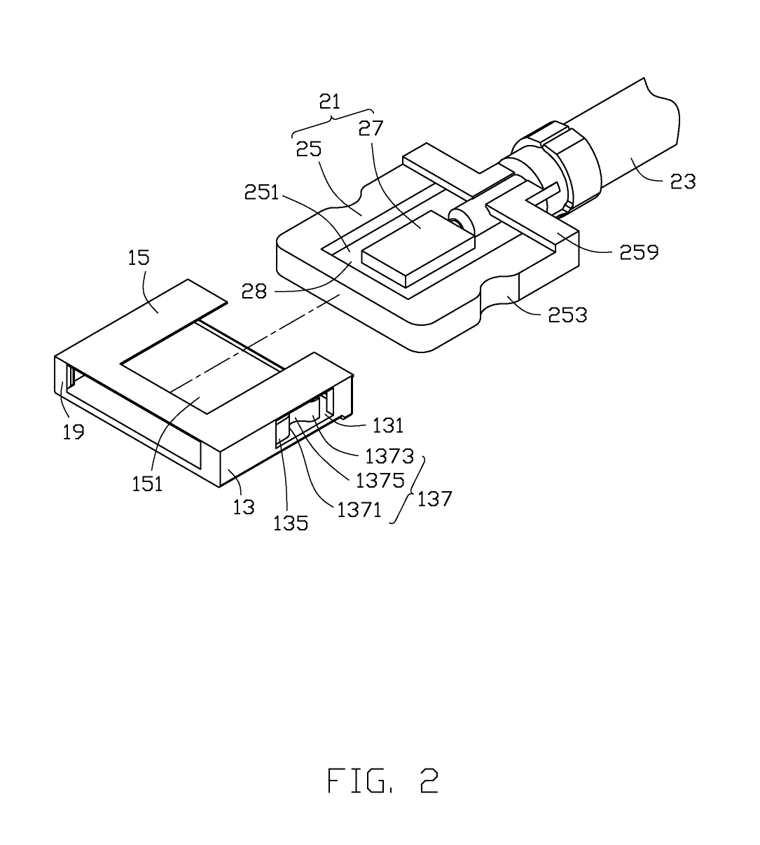

FIG. 2 illustrates the shielding shell 10 and a connector 20 of the electronic device. The shielding shell 10 is made of non-magnetic materials which shield against electromagnetic interference, and comprises a top plate 11, side plates 13 perpendicularly extending down from opposite side edges of the top plate 11 and a bottom plate 15 formed between the two side plates 13 and opposite to the top plate 11. An entrance 16 is defined at a front end of the shielding shell 10. The top plate 11, the two side plates 13 and the bottom plate 15 cooperatively define a receiving space 17. A blocking board 19 is formed at a rear end of the shielding shell 10. A cutout 151 is defined in a middle portion of the bottom plate 15 and extends through a front edge of the bottom plate 15. A rectangular opening 131 is defined in each of the side plates 13. An elastic fixing tab 133 extends from a rear end of the opening 131 and extends into the opening 131. Each fixing tab 133 comprises a connecting piece 135 extending from the side plate 13, and a projecting portion 137 extending from a distal end of the connecting piece 135. The projecting portion 137 comprises a connecting portion 1371 slantingly extending from a distal end of the connecting piece 135, a curved securing portion 1375 extending from a distal end of the connecting piece 135, and an extending portion 1373 extending from a distal end of the securing portion 1375. The securing portion 1375 extends into the receiving space 17.

The connector 20 comprises a plug 21 and a cable 23. The plug 21 comprises a rectangular shielding body 25 and a signal connector 27. A rectangular cavity 251 is defined in a lower portion of the shielding body 25. An insulating layer 28 is formed on inner surfaces of the cavity 251. The signal connector 27 is received in the cavity 251. The insulating layer 28 is located between the shielding body 25 and the signal connector 27, for insulating the signal connector 27 from shielding body 25. A stopper bar 259 is formed at one end of the shielding body 25 and the cable 23 extends through the stopper bar 259 to connect with the signal connector 27. A notch 253 is defined in each of two opposite sides of the shielding body 25.

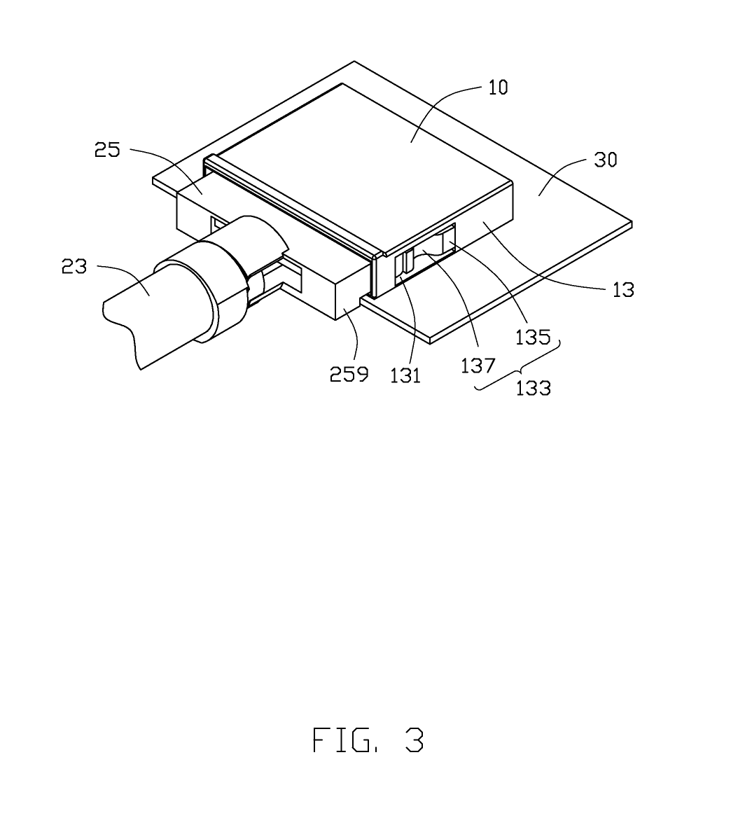

FIG. 3 illustrates the assembled electronic device. The shielding shell 10 is attached to the circuit board 30, with the signal piece 31 extending through the cutout 151 and the bottom plate 15 being soldered on the connecting member 32. The entrance 16 is in alignment with the opening of the connecting member 32. The plug 21 is inserted into the shielding shell 10 via the entrance 16, with the signal connector 27 electronically connecting with the signal piece 31 and the fixing tab 133 deformably engaging in the notches 253. The plug 21 is fixed in the shielding shell 10. The stopper bar 259 can be stopped by the front end of the circuit board 30, and an end of the shielding body 25 away from the cable 23 can be stopped by the blocking board 19.

The plug 21 of the connector 20 can be easily detached from the shielding shell 10 when the fixing tab 133 is deformed, to move out of the notches 253.

The embodiments shown and described above are only examples. Even though numerous characteristics and advantages of the present technology have been set forth in the foregoing description, together with details of the structure and function of the present disclosure, the disclosure is illustrative only, and changes may be made in the details, including matters of shape, size, and arrangement of the parts within the principles of the present disclosure, up to and including the full extent established by the broad general meaning of the terms used in the claims.

What is claimed is:

1. An electronic device comprising:
a circuit board comprising a signal piece and a connecting member partially surround the signal piece;
a shielding shell attached to the connecting member and comprising at least one elastic fixing tab; and
a connector comprising a plug detachably plugged in the shielding shell to electronically coupled with the signal piece, the plug comprising at least one notch to engage with the fixing tab.

2. The electronic device of claim 1, wherein the shielding shell comprises a top plate, two side plates respectively perpendicularly extending down from two opposite side edges of the top plate and a bottom plate formed between the two side plates and opposite to the top plate, a cutout is defined in the bottom plate for the fixing tab extending therethrough to couple with the plug, an entrance is formed at one end of the shielding shell for the plug accessing into the shielding shell.

3. The electronic device of claim 2, wherein a blocking board is formed at an end of the shielding shell opposite to the entrance.

4. The electronic device of claim 2, wherein at least one side plate of the shielding shell defines an opening, and the fixing tab extends from the side plate and extends into the opening.

5. The electronic device of claim 4, wherein the fixing tab comprises a connecting piece extending from the side plate and a projecting portion extending from to a distal end of the connecting piece.

6. The electronic device of claim 5, wherein the projecting portion comprises a connecting portion slantingly extending from the connecting piece, a curved securing portion extending from the connecting portion, and an extending portion extending from a distal end of the securing portion, the securing portion extends into the shielding shell.

7. The electronic device of claim 1, wherein the plug comprises a signal connector coupled with the signal piece, and a shielding body defining a cavity to receive the signal connector, an insulating layer is formed on inner surfaces of the cavity to insulating the signal connector from the shielding body.

8. The electronic device of claim 7, wherein the shielding body comprises a stopper bar formed at one end thereof to be stopped by an edge of the circuit board.
